(19) United States
(12) Patent Application Publication
(10) Pub. No.: US 2007/0293253 A1
(43) Pub. Date: Dec. 20, 2007

(54) Mobile terminal, mail notification method and mail notification program

(75) Inventors: Fumiaki Matsumoto, Higashiosaka-shi (JP); Michiaki Koizumi, Daito-shi (JP)

Correspondence Address: KRATZ, QUINTOS & HANSON, LLP, 1420 K Street, N.W., Suite 400, WASHINGTON, DC, 20005, US

(73) Assignee: SANYO ELECTRIC CO., LTD., Moriguchi-shi (JP)

(21) Appl. No.: 11/808,051

(22) Filed: Jun. 6, 2007

(30) Foreign Application Priority Data
Jun. 15, 2006 (JP) 2006-165657

(51) Int. Cl. H04Q 7/20

(52) U.S. Cl. 455/466

(57) ABSTRACT

The invention relates to a mobile terminal that sends content of emails only to a terminal having a telephone number which has been set on the mobile terminal by the owner. One or more telephone numbers to which content of emails is to be sent are stored in the storage unit 12, together with the emails. When an incoming-call notice is presented, the control unit 11 judges whether the telephone number of the calling terminal is one of the telephone numbers stored in the storage unit 12. When the judgment is affirmative, the control unit 11 sends the content of emails stored in the storage unit 12 to the calling terminal.

### BACKGROUND OF THE INVENTION

(1) Field of the Invention

The present invention relates to a technology that allows contents of emails accumulated in a mobile terminal to be seen or listened to on a different mobile terminal.

(2) Description of the Related Art

Conventionally, land-line phones and the like have an answering machine function, and various services using such a function have been provided or proposed.

For example, the user of a terminal on the called side is sometimes in a situation that he/she cannot answer the phone. In such a case, some terminals have a function of making a response with an answering message according to the place where the user is now or the user's schedule, rather than responding with the same message to a terminal on the calling side in a single uniform way.

### SUMMARY OF THE INVENTION

The mobile terminal of the present invention has a telephone function and an email transmitting and receiving function, and comprises a sending unit operable to, when an incoming-call notice is presented, retrieve an email stored in a mail storage unit and send content of the retrieved email to a calling terminal.

The mail notification method of the present invention is used on a mobile terminal having a telephone function and an email transmitting and receiving function. The mail notification method comprises the step of retrieving, when an incoming-call notice is presented, an email stored in a mail storage unit and sending content of the retrieved email to a calling terminal.

The mail notification program of the present invention causes a mobile terminal that has a telephone function and an email transmitting and receiving function to execute the step of retrieving, when an incoming-call notice is presented, an email stored in a mail storage unit and sending content of the retrieved email to a calling terminal.

### BRIEF DESCRIPTION OF THE DRAWINGS

These and other objects, advantageous effects and features of the invention will become apparent from the following description thereof taken in conjunction with the accompanying drawings which illustrate specific embodiments of the invention. In the drawings:

FIG. 1 shows a system structure of a message answering system that is one embodiment of the present invention;

FIG. 2 shows a structure of mobile phones of FIG. 1;

FIG. 3 shows an example of an address book stored in a storage unit of FIG. 2;

FIG. 4 shows an example of a readout target setting table stored in the storage unit of FIG. 2;

FIG. 5 shows an example of a readout target setting screen displayed on a display unit of FIG. 2;

FIG. 6 shows an example of a readout mail selecting screen displayed on the display unit of FIG. 2;

FIG. 7 is a functional block diagram of a control unit of FIG. 2; and

FIG. 8 is a flowchart showing a flow of operations performed by the mobile phones of FIG. 1.

### DESCRIPTION OF THE PREFERRED EMBODIMENT

The following explains an embodiment of the present invention with reference to drawings.

<Message Answering System>

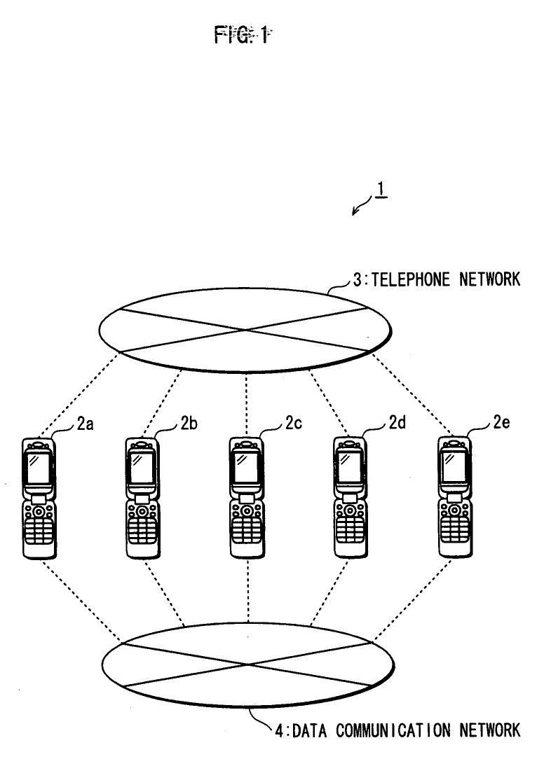

A system structure of a message answering system of the present embodiment is described with reference to FIG. 1. FIG. 1 shows a system structure of the message answering system of the present embodiment.

A message answering system 1 includes mobile phones 2a-2e, each of which is connected to a telephone network 3 and a data communication network 4. Note that the mobile phones may be another type of mobile terminals.

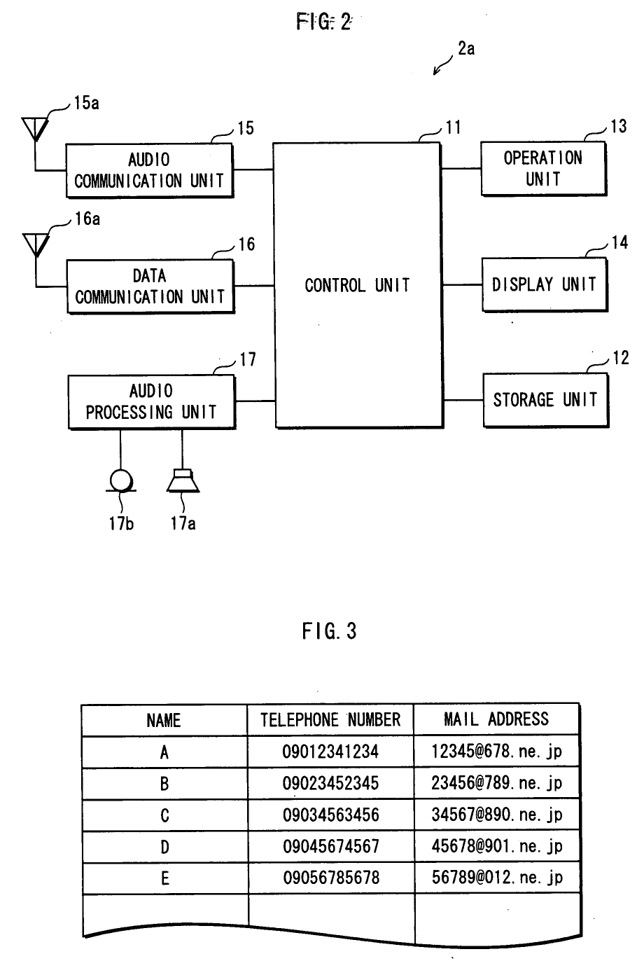

The mobile phones 2a-2e have a telephone function and email transmission and reception functions, and have a storage device (a storage unit 12 of FIG. 2) that stores therein transmitted and received emails. When the mobile phones 2a-2e have received an incoming call, they convert data related to contents of main bodies, titles or the like of the emails stored in the storage device into an audio signal in accordance with the telephone number of the calling side. Then, the mobile phones 2a-2e transmit the converted audio signal to a terminal on the calling side using their telephone function. Note that the mobile phones 2a-2e on the called side can obtain the terminal's telephone number on the calling side through caller ID notification services or the like.

The system operation of the message answering system 1 of FIG. 1 is outlined next. Here, assume that the mobile phone 2a is the calling side while the mobile phone 2b is the called side.

When the user of the mobile phone 2a performs an operation to make a call to the mobile phone 2b by, for example, specifying the telephone number of the mobile phone 2b, the mobile phone 2a makes a calling request to the mobile phone 2b via the telephone network 3. An incoming-call notice, in response to the calling request, is made on the mobile phone 2b.

When a predetermined time has elapsed after the incoming-call notice, the mobile phone 2b judges whether the telephone number of the mobile phone 2a on the calling side is a telephone number to which content of an email should be sent. In the case where the judgment is affirmative, the mobile phone 2b selects, from among emails stored in the storage device, an e-mail that is an object to be sent to the mobile phone 2a and converts the title, main body or other text data of the email into an audio signal. Subsequently, the mobile phone 2b transmits the converted audio signal to the mobile phone 2a via the telephone network 3. The mobile phone 2a receives the audio signal, converts the received audio signal into audio, and then outputs the audio from the speaker.

<Mobile Phone>

Structure

The structure of the mobile phones 2a-2e of FIG. 1 is explained next with reference to FIG. 2. FIG. 2 is a structural diagram of the mobile phones of FIG. 1. Since all the mobile phones 2a-2e have the same functional structure regarding the present invention, the following description is given with an example of the mobile phone 2a.

The mobile phone 2a includes: a control unit 11; a storage unit 12; an operation unit 13; a display unit 14; an audio communication unit 15; an antenna 15a; a data communication unit 16; an antenna 16a; an audio processing unit 17; a speaker 17a; and a microphone 17b.

The control unit 11 performs control on the entire mobile phone 2a, which will be described in detail below.

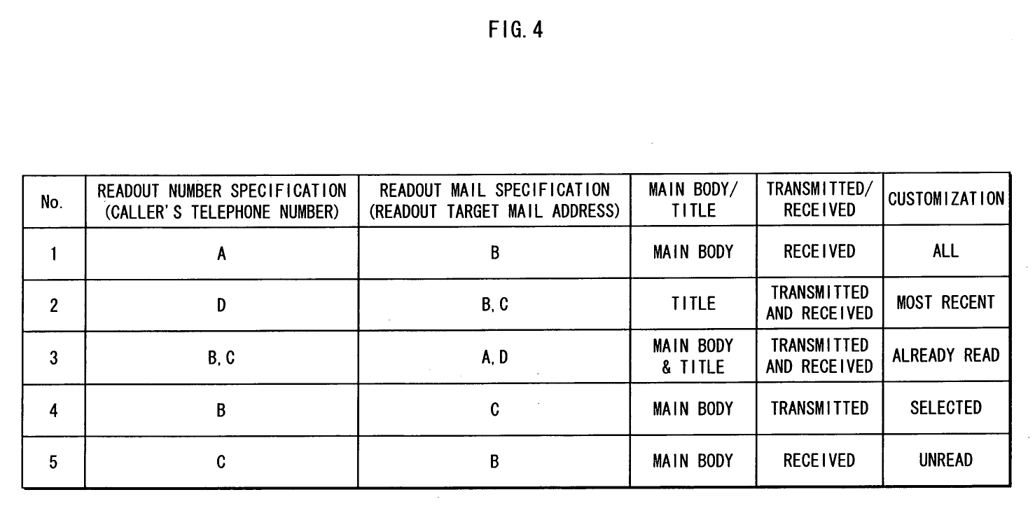

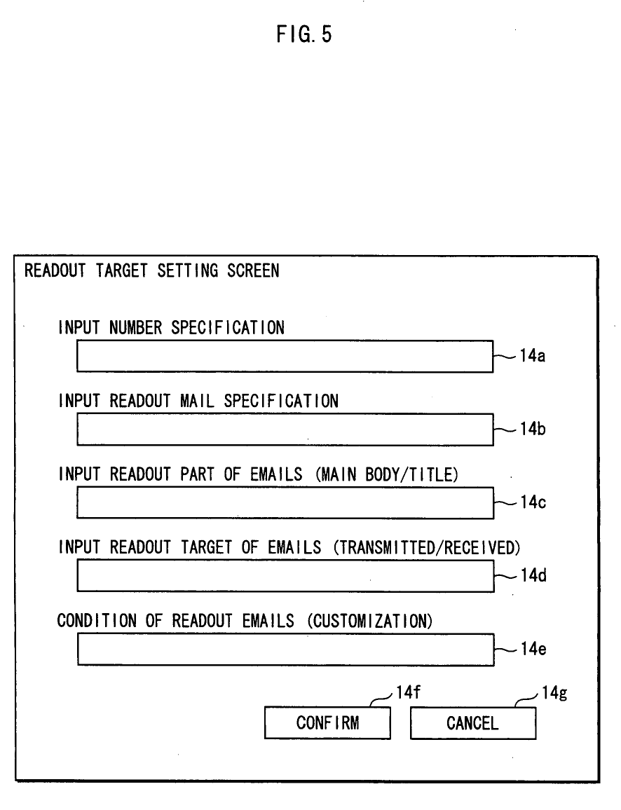

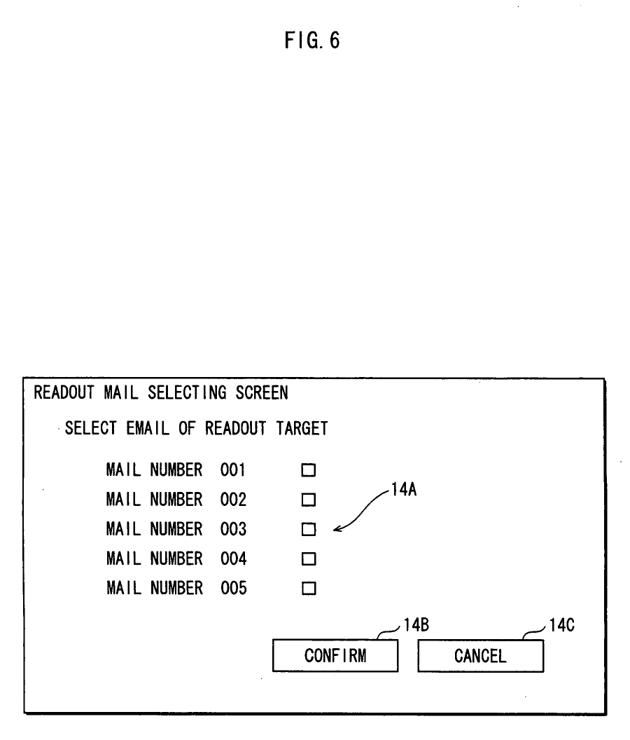

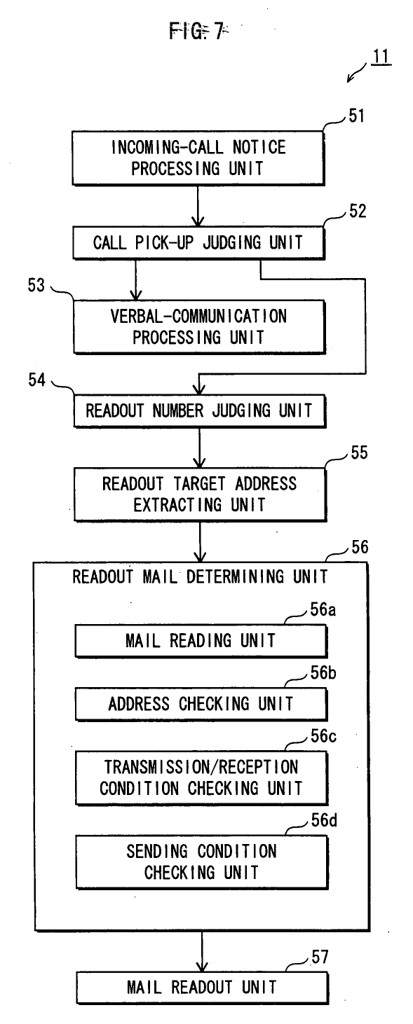

In the storage unit 12, various control programs for controlling the mobile phone 2a and various types of application software are stored. In addition, the storage unit 12 stores therein: an address book, an example of which is shown in FIG. 3; a readout target setting table, an example of which is shown in FIG. 4; and emails. Furthermore, the storage unit 12 stores therein information showing, with respect to each email, whether the email is unread or already-read and the time and date of transmission/reception of the email. The storage unit 12 also stores therein a flag for a mail number of each email. The flag of an email that has been selected on a readout mail selecting screen of FIG. 6 to be hereinafter described is set to 1.

The address book, whose example is shown in FIG. 3, includes fields of “name”, “telephone number” and “email address”.

Names are stored in the field “name”. In the field “telephone number”, telephone numbers of, for example, mobile phones owned by users whose names correspond to each of the telephone numbers are stored. The field “mail address” stores therein email addresses of, for example, mobile phones owned by users whose names correspond to each of the mail addresses.

The readout target setting table, whose example is shown in FIG. 4, includes fields of “No.”, “readout number specification”, “readout mail specification”, “main body/title”, “transmitted/received” and “customization”.

The field “readout number specification” stores therein the owner's name of a target terminal, to which content of an email/emails is to be sent. Note that the field “readout number specification” may store therein names of more than one person.

The field “readout mail specification” stores therein the owner's name of a transmission-source terminal or a destination terminal which transmitted or received an email/emails whose content is to be read out in a terminal owned by a person whose name is stored in the corresponding field “readout number specification”. Note that the field “readout mail specification” may store therein names of more than one person.

The filed “main body/title” stores therein information regarding a section of an email/emails to be read out (hereinafter referred to as the “readout section condition”). This field stores “main body” in the case of reading out only the main body, “title” in the case of reading out only the title, and “main body & title” in the case of reading out both main body and title.

The field “transmitted/received” stores therein information regarding whether an email/emails to be sent to a corresponding target terminal are transmitted mails, received mails, or both transmitted and received mails (hereinafter referred to as the “transmission/reception condition”). This field stores “transmitted” in the case of sending, to the target terminal, only an email/emails having been transmitted by the mobile phone 2a, and “received” in the case of sending only an email/emails having been received by the mobile phone 2a. In addition, in the case of sending both an email/emails having been transmitted and received by the mobile phone 2a, “transmitted and received” is stored in the field “transmitted/received”.

The field “customization” stores therein condition showing a type of email/emails to be sent to the target terminal (hereinafter referred to as the “sending condition”). This field stores “all” in the case of sending all emails to the destination terminal, and “most recent” in the case of sending only the most recent, for example, ten emails. Furthermore, this field stores “already read” in the case of sending only an email/emails having already been read to the destination terminal, and “selected” in the case of sending only an email/emails having been selected as a sending object. In addition, in the case of sending only an email/emails having not been read, “unread” is stored in the field “customization”.

The operation unit 13 is composed of various keys, and outputs a push-down signal of the pushed key to the control unit 11.

The display unit 14 is formed with a liquid crystal display and the like, and displays display data input from the control unit 11. For example, a readout target setting screen, one example of which is shown in FIG. 5, and a readout mail selecting screen, one example of which is shown in FIG. 6, are displayed on the display unit 14.

The readout target setting screen of FIG. 5 includes a readout number specification entry box 14a for entering the owner's name of a target terminal, to which content of email/emails is to be sent.

The readout target setting screen includes a readout mail specification entry box 14b for entering the owner's name of a transmission-source terminal or a destination terminal which transmitted or received an email/emails whose content is to be read out in a terminal owned by a person whose name has been entered in the readout number specification entry box 14a.

Note that names of more than one person can be entered in each of the readout number specification entry box 14a and the readout mail specification entry box 14b.

The readout target setting screen includes: a main body/title entry box 14c for entering information regarding a section of an email/emails to be read out (readout section condition); a transmitted/received entry box 14d for entering information regarding whether an email/emails to be sent to the target terminal are transmitted mails or the like (transmission/reception condition); and a customization entry box 14e for entering condition of an email/emails to be sent to the target terminal (sending condition).

The readout target setting screen includes a confirm button 14f to be pushed in the case of confirmation and a cancel button 14g to be pushed in the case of cancellation.

When the confirm button 14f is pushed, the control unit 11 performs processing and thereby the entry contents entered in the readout number specification entry box 14a, readout mail specification entry box 14b, main body/title entry box 14c, transmitted/received entry box 14d, and customization entry box 14e are stored in the corresponding fields of a record of the readout target setting table of FIG. 4—i.e. the “readout number specification”, “readout mail specification”, “main body/title”, “transmitted/received”, and “customization”, respectively.

The readout mail selecting screen, whose example is shown in FIG. 6, includes a checkbox 14A for a mail number of each email, in addition to a confirm button 14B to be pushed in the case of confirmation and a cancel button 14C to be pushed in the case of cancellation.

When the confirmation button 14B is pushed, the control unit 11 performs processing and thereby, among from flags of emails stored in the storage unit 12, a flag of an email having a mail number whose checkbox 14A has been ticked is set to 1.

The audio communication unit 15 is a communication unit for audio communication, and transmits and receives audio signals with other terminals connected to the telephone network 3 via the antenna 15a. The audio communication unit 15 outputs a reception signal received by the antenna 15a to the control unit 11, and transmits, from the antenna 15a, a transmission signal input from the control unit 11.

The data communication unit 16 is a communication unit for data communication, and transmits and receives data signals with other terminals connected to the data communication network 4 via the antenna 16a. The data communication unit 16 outputs a reception signal received by the antenna 16a to the control unit 11, and transmits, from the antenna 16a, a transmission signal input from the control unit 11.

The audio processing unit 17 converts a digital signal input from the control unit 11 into an analogue signal and outputs the analogue signal to the speaker 17a. The speaker 17a outputs audio by converting the analogue signal input from the audio processing unit 17. The microphone 17b collects sounds around it and outputs the sounds to the audio processing unit 17. The audio processing unit 17 converts an analogue signal input from the microphone 17b into a digital signal and outputs the digital signal to the control unit 11.

[Control Unit]

The functional structure of the control unit 11 of FIG. 2 is explained with reference to FIG. 7. FIG. 7 is a functional block diagram of the control unit 11 of FIG. 2. Note that the control unit 11 has, besides functions shown in FIG. 7, a function of making a calling request to a telephone number input from the operation unit 13 via the audio communication unit 15 and antenna 15a, and a function of storing, in the storage unit 12, emails received by the antenna 16a and then input from the data communication unit 16.

The control unit 11 functions as an incoming-call notice processing unit 51, a call pick-up judging unit 52, a verbal-communication processing unit 53, a readout number judging unit 54, a readout target address extracting unit 55, a readout mail determining unit 56 and a mail readout unit 57.

The incoming-call notice processing unit 51 monitors a signal input from the audio communication unit 15 and waits for an incoming-call notice from a terminal, such as another mobile phone or a land-line phone. In addition, when an incoming-call notice is presented, the incoming-call notice processing unit 51 performs a calling process by, for example, making a ringtone from the speaker 17a via the audio processing unit 17.

After an incoming-call notice is presented, the call pick-up judging unit 52 judges, based on a push-down signal input from the operation unit 13, whether a call pick-up operation has been performed.

In response to the call pick-up operation, the verbal-communication processing unit 53 establishes a line with the terminal on the calling side. Then, the verbal-communication processing unit 53 outputs an audio signal received by the antenna 15a and then input from the audio communication unit 15 via the audio processing unit 17 and the speaker 17a. In addition, the verbal-communication processing unit 53 outputs an audio signal collected by the microphone 17b and then input from the audio processing unit 17 via the audio communication unit 15 and the antenna 15a.

The readout number judging unit 54 judges, with reference to an address book (see FIG. 3) and a readout target setting table (FIG. 4), whether the telephone number of the calling side is a telephone number to which content of an email/emails are supposed to be sent.

The readout target address extracting unit 55 identifies a mail address/mail addresses of an email/emails to be sent with reference to an address book (see FIG. 3) and a readout target setting table (FIG. 4), besides identifying the readout section condition, transmission/reception condition, and sending condition.

The readout mail determining unit 56 functions as a mail reading unit 56a, an address checking unit 56b, a transmission/reception condition checking unit 56c and a sending condition checking unit 56d.

The mail reading unit 56a reads emails stored in the storage unit 12 therefrom.

The address checking unit 56b checks any one of email addresses of transmission sources and destinations read by the mail reading unit 56a is a mail address of an email to be sent, which has been determined by the readout target address extracting unit 55.

The transmission/reception condition checking unit 56c checks whether emails read by the mail reading unit 56a meet the transmission/reception condition identified by the readout target address extracting unit 55.

The sending condition checking unit 56d checks whether emails read by the mail reading unit 56a meet the sending condition identified by the readout target address extracting unit 55.

Regarding, among emails read by the mail reading unit 56a, an email/emails which have been determined to have mail addresses to be sending targets and to satisfy the transmission/reception condition and the sending condition, the mail readout unit 57 converts such email/emails into an audio signal according to the readout section condition identified by the readout target address extracting unit 55. The mail readout unit 57 transmits the converted audio signal to the terminal on the calling side via the audio communication unit 15 and antenna 15a.

Operations

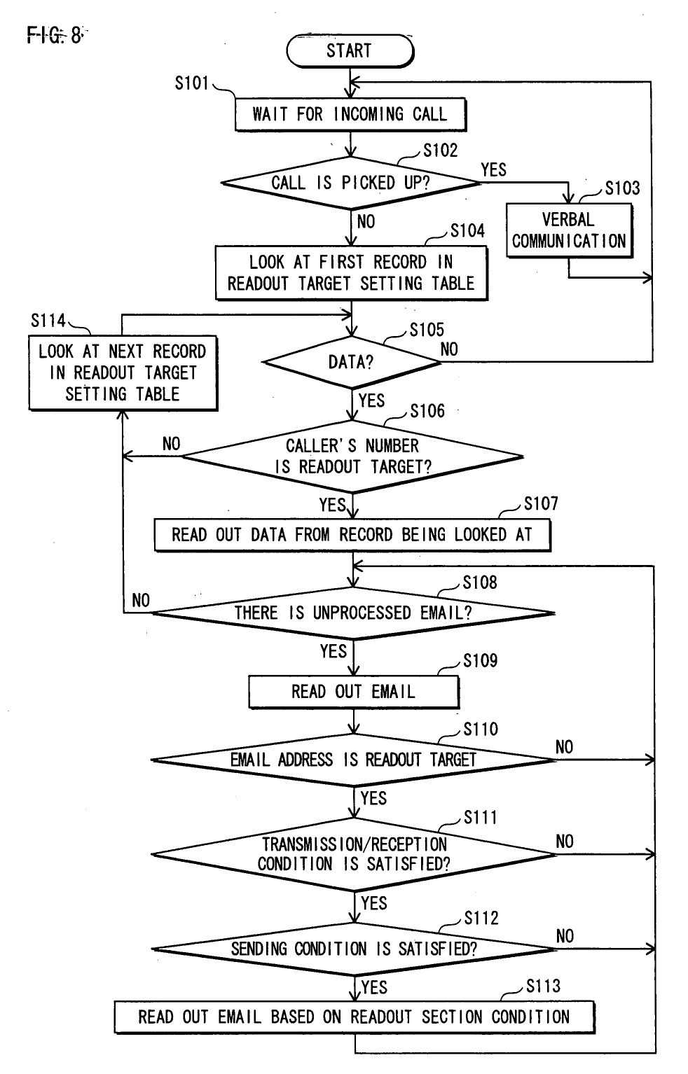

The operations of the mobile phones 2a-2e of FIG. 1 are explained with reference to FIG. 8. FIG. 8 is a flowchart showing a flow of operations of the mobile phones. Since the flow of operations regarding the present invention is the same among all the mobile phones 2a-2e, the following description is given with an example of the mobile phone 2a.

The incoming-call notice processing unit 51 monitors a signal input from the audio communication unit 15 and waits for an incoming-call notice from a terminal, such as another mobile phone or a land-line phone. When an incoming-call notice is presented, the incoming-call notice processing unit 51 performs a calling operation (Step S101).

The call pick-up judging unit 52 judges, based on a push-down signal input from the operation unit 13, whether a call pick-up operation has been performed (Step S102). When the call pick-up judging unit 52 determines that the call pick-up operation has been performed (S102: YES), the verbal-communication processing unit 53 performs a verbal communication process (Step S103), and then returns to Step S101. On the other hand, when the call pick-up operation is not performed and then a predetermined period of time has elapsed after the calling operation (S102: NO), the process moves to Step S104.

The readout number judging unit 54 looks at the first record in the readout target setting table (Step S104).

The readout number judging unit 54 judges whether the record looked in Step S104 or Step S114 to be hereinafter described has data (Step S105). When it is determined that the record has no data (S105: NO), the process returns to Step S101; when it is determined that the record has data (S105: YES), the process moves to Step S106.

The readout number judging unit 54 identifies the owner's name of a terminal having a telephone number of the calling side with reference to the address book. Then, the readout number judging unit 54 judges whether this owner's name is included in names in the field “readout number specification” of the record being looked at. That is, the readout number judging unit 54 judges whether the telephone number of the calling side (caller's number) is a telephone number, to which content of an email/emails is read out (Step S106). When the caller's number is a readout-target telephone number (S106: YES), the process moves to Step S107; when the caller's number is not a readout-target telephone number (S106: NO), the readout number judging unit 54 looks at the next record in the readout target setting table (Step S114) and returns to Step S105.

The readout target address extracting unit 55 reads out the name, readout section condition, transmission/reception condition and sending condition from the fields “readout mail specification”, “main body/title”, “transmitted/received” and “customization”, respectively, of the record looked in the readout target setting table. Subsequently, the readout target address extracting unit 55 reads an email address from the address book with respect to each name read from the field “readout mail specification” (Step S107).

The mail reading unit 56a checks, in the process for the record currently being looked at, whether there is unprocessed email in the storage unit 12 (Step S108). If there is no unprocessed email in the storage unit 12 (S108: NO), the readout number judging unit 54 looks at the next record in the readout target setting table (Step S114), and returns to Step S105. On the other hand, there is an unprocessed email in the storage unit 12 (S108: YES), the mail reading unit 56a reads one unprocessed email from the storage unit 12 in order of most recently transmitted/received (Step S109) and moves to Step S110.

The address checking unit 56b judges whether any one of the mail addresses of transmission sources and destinations of the emails read by the mail reading unit 56a matches one of email addresses read from the address book in Step S107. That is, the address checking unit 56b judges whether the mail address of a read email is a mail address of a readout target (Step S110). If it is not a mail address of a readout target (S110: NO), the process returns to Step S108; when it is a mail address of a readout target (S110: YES), the process moves to Step S111.

The transmission/reception condition checking unit 56c judges whether a read email meets the transmission/reception condition read in Step S107 (Step S111). If the read email does not meet the transmission/reception condition (S111: NO), the process returns to Step S108; when it meets the transmission/reception condition (S111: YES), the process moves to Step S112.

In the case where the sending condition is “selected”, the sending condition checking unit 56d also refers to a flag for the email, which is stored in the storage unit 12, and judges whether the read email meets the sending condition read in Step S107 (Step S112). When the read email does not meet the sending condition (S112: NO), the process returns to Step S108; when it meets the sending condition (S112: YES), the process moves to Step S113.

The mail readout unit 57 converts the read email into an audio signal in accordance with the readout section condition read in Step S107, and transmits the converted audio signal to the terminal on the calling side. The terminal on the calling side received the audio signal converts the received audio signal into audio, and outputs the audio from the speaker (Step S113). Then, the process returns to Step S108.

According to the above-described embodiment, content of an email/emails can be sent as response content to the calling side in response to an incoming-call notice. Note that, in services having been provided or proposed up to date, the response content is audio messages, and no services have been present for response content designed for emails like the present embodiment.

In addition, the present embodiment has a structure that allows for registering, to the readout number specification, a name to which content of an email/emails is to be sent. Therefore, only a mobile phone owned by a person, to which the owner of the mobile phone on the called side desires to send content of an email/emails, can be set as a mobile phone on the calling side, to which the mobile phone on the called side sends the content of an email/emails.

For example, if the response content is content of an email/emails regarding a meeting up, it is possible to give an audio output of the content of the email/emails in response to only an incoming-call notice from a person for the meeting up. It is also possible to prevent content of an email/emails from being sent in response to an incoming-call notice from a person considered to be inappropriate to be passed the content of the email/emails.

In addition, the present embodiment allows mail addresses of emails for readout targets to be registered in the readout mail specification. Accordingly, only emails that the owner of the mobile phone on the called side desires to impart to a person owning a mobile phone on the calling side can be set as emails to be sent by the mobile phone on the called side to the mobile phone on the calling side.

Furthermore, the owner of the terminal on the calling side is able to listen to content of emails stored in a mobile terminal in audio simply by calling the mobile terminal.

<Supplementary Remarks>

(1) The above embodiment is described using, as an example, the case in which the owners' names of target terminals to which emails are to be sent are stored in the field “readout number specification” of FIG. 4. However, telephone numbers of the target terminals may be stored therein instead.

The embodiment is also described with the case in which the owners' names of transmission-source terminals or destination terminals of emails to be sent are stored in the field “readout mail specification” of FIG. 4. However, email addresses of these terminals may be stored therein instead.

Furthermore, a table may be separately prepared in which a name of each group is associated with one or more people's names included in the group, as well as with their telephone numbers and email addresses (e.g. address book), and the group names may be stored in the fields “readout number specification” and “readout mail specification” of FIG. 4. Storing the group names in the field “readout number specification” means that sending condition corresponding to each group is stored in the field “customization”.

For example: the group names are stored in the field “readout number specification”, and one or more people's names or telephone numbers are stored in the field “readout mail specification”; one or more people's names or telephone numbers are stored in the field “readout number specification”, and the group names are stored in the field “readout mail specification”; or the group names are stored in the field “readout number specification”, and the group names are stored in the field “readout mail specification”.

(2) The above embodiment is described with the case in which, in order to send content of an email/emails to the terminal on the calling side, the content of an email/emails is converted into an audio signal and the converted audio signal is transmitted to the terminal on the calling side. The present invention is, however, not limited to this case, and the email/emails as they are can be transmitted to the terminal on the calling side.

(3) The above embodiment may be made in such a manner that an owner of a terminal transmitting an email is able to specify whether a terminal on the receiving side can read out content of the transmitted email to a different terminal.

(4) For the mobile phones of the above embodiment, an additional function may be provided that, for example, records simple voicemails after converting content of an email/emails into an audio signal and transmitting the audio signal to a terminal on the calling side.

(5) The field “customization” described in the above embodiment may further store therein information indicating, for example, that: based on the transmission and reception history, content of an email/emails received after the terminal on the called side made a phone call with a terminal having a telephone number of the calling side for the last time is to be sent to a destination terminal; or content of an email/emails transmitted and received over a predetermined time period (e.g. one day) prior to an incoming-call notice is to be sent to a destination terminal.

(6) For the mobile phones of the above embodiment, additional functions may be provided that cause the audio readout of an email/emails to be stopped or paused and that cause the content readout to be skipped to the next email, in accordance with a command from a mobile phone on the calling side.

(7) The field “transmitted/received” described in the above embodiment may further store therein information indicating that an email replied to a received mail is set as an email, the content of which is to be read out.

(8) The mobile phones of the above embodiment may be made in such a manner to convert, when an audio signal of the main body or the title of the email is transmitted to a terminal on the calling side, content of the email header (destination, transmission source, or the like) and the transmitted/received date of the email into an audio signal, and the converted audio signal may be transmitted together.

In addition, the content of an email/emails to be sent may be a part of the main body of the email/emails.

(9) A program in which a procedure equivalent to a process described in the above embodiment may be stored in a memory, and the process can be executed using a CPU (Central Processing Unit) or the like. Additionally, the program may be recorded on a recording medium, such as a computer readable CD-ROM.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be constructed as being included therein.

What is claimed is:

1. A mobile terminal having a telephone function and an email transmitting and receiving function, comprising:
a sending unit operable to, when an incoming-call notice is presented, retrieve an email stored in a mail storage unit and send content of the retrieved email to a calling terminal.

2. The mobile terminal of claim 1, further comprising:
a judging unit operable to, when the incoming-call notice is presented, judge whether a telephone number of the calling terminal is stored in a sending target storage unit storing therein a telephone number to which the content of the email is to be sent,
wherein the sending unit sends, when judgment of the judging unit is affirmative, the content of the email.

3. The mobile terminal of claim 2, wherein
the sending target storage unit stores therein one or more addresses which correspond to one or more telephone numbers, the addresses being addresses of emails which are to be sent to terminals having the corresponding telephone numbers, and
the sending unit sends, from among emails stored in the mail storage unit, content of one or more emails of which at least one of an original transmission source and an original destination has an address corresponding to the telephone number of the calling terminal.

4. The mobile terminal of claim 2, wherein
the sending target storage unit stores therein one or more addresses which correspond to a telephone number group including one or more telephone numbers, the addresses being addresses of emails which are to be sent to terminals having the corresponding telephone numbers included in the telephone number group, and
the sending unit sends, from among emails stored in the mail storage unit, content of one or more emails of which at least one of an original transmission source and an original destination has an address corresponding to a telephone number group including the telephone number of the calling terminal.

5. The mobile terminal of claim 2, wherein
the sending target storage unit stores therein an address group including one or more addresses which correspond to one or more telephone numbers, the addresses being addresses of emails which are to be sent to terminals having the corresponding telephone numbers, and
the sending unit sends, from among emails stored in the mail storage unit, content of one or more emails of which at least one of an original transmission source and an original destination has an address included in an address group corresponding to the telephone number of the calling terminal.

6. The mobile terminal of claim 2, wherein
the sending target storage unit stored therein an address group including one or more addresses which correspond to a telephone number group including one or more telephone numbers, the addresses being addresses of emails which are to be sent to terminals having the corresponding telephone numbers included in the telephone number group, and
the sending unit sends, from among emails stored in the mail storage unit, content of one or more emails of which at least one of an original transmission source and an original destination has an address included in an address group corresponding to a telephone number group including the telephone number of the calling terminal.

7. The mobile terminal of claim 2, wherein
the sending target storage unit stores therein a transfer condition corresponding to one or more telephone numbers, the transfer condition indicating a type of email to be sent, and
the sending unit sends, from among emails stored in the mail storage unit, content of one or more emails that meet a transfer condition corresponding to the telephone number of the calling terminal.

8. The mobile terminal of claim 2, wherein
the sending target storage unit stores therein a transfer condition corresponding to a telephone number group, including one or more telephone numbers, the transfer condition indicating a type of email to be sent, and
the sending unit sends, from among emails stored in the mail storage unit, content of one or more emails that meet a transfer condition corresponding to a telephone number group including the telephone number of the calling terminal.

9. The mobile terminal of claim 1, wherein
so as to send the content of the email, the sending unit converts data pertaining to the content of the email into an audio signal and transmits the audio signal using the telephone function.

10. A mail notification method used on a mobile terminal having a telephone function and an email transmitting and receiving function, comprising the step of:
retrieving, when an incoming-call notice is presented, an email stored in a mail storage unit and sending content of the retrieved email to a calling terminal.

11. A mail notification program causing a mobile terminal that has a telephone function and an email transmitting and receiving function to execute the step of:
retrieving, when an incoming-call notice is presented, an email stored in a mail storage unit and sending content of the retrieved email to a calling terminal.
